(19) United States
(12) Patent Application Publication
(10) Pub. No.: US 2005/0165136 A1
(43) Pub. Date: Jul. 28, 2005

(54) Glass-ionomer cements containing amino acids

(75) Inventors: Jimmy Wayne Mays, Knoxville, TN (US); Dong Xie, Indianapolis, IN (US); Aaron D. Puckett Jr., Madison, MS (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: UAB Research Foundation, Birmingham, AL (US)

(21) Appl. No.: 10/501,754

(22) PCT Filed: Jan. 22, 2003
(86) PCT No.: PCT/US03/01985

Related U.S. Application Data
(60) Provisional application No. 60/351,144, filed on Jan. 23, 2002.

(51) Int. Cl. C08L 1/00; C08K 3/00; C08F 20/06

(52) U.S. Cl. 524/3; 524/5; 524/556; 526/317.1; 526/319

(57) ABSTRACT

Disclosed are ionomeric compositions and ionomeric cements containing the compositions. The cements are useful in dental and orthopedic medicine.

### BACKGROUND OF THE INVENTION

Glass-ionomer cements were first developed about thirty years ago [1]. Glass-ionomer cements typically contain an ionic polymer composition such as an acrylic acid homo- or co-polymer, and a reactive glass composition such as a calcium fluoride-alumino-silicate glass powder. The ionic polymer is provided in aqueous liquid form, and the reactive glass is provided in powdery form. When these two compositions are mixed in water, a cement setting reaction takes place. These cements are known for their unique properties such as direct adhesion to tooth structure and base metal [2, 3], anticariogenic properties due to release of fluoride [4], thermal compatibility with tooth enamel and dentin because of low coefficients of thermal expansion similar to those of tooth structure [5], minimized microleakage at the tooth-enamel interface due to low shrinkage [6], biological compatibility and low cytotoxicity [7,8]. An acid-base interaction plays a major role in conventional glass-ionomer cements or self-cured cements [9, 10]. A similar interaction occurs when the cement contacts tooth enamel or dentin, which mainly contains hydroxyapatite (Ca²⁺ and PO⁴⁻), and Type I collagen [6, 11]. Salt bridge formation is an essential aspect to the adhesion. Due to the salt bridges that form between the cement and tooth surfaces, these cements have been particularly useful as dental adhesives and anterior tooth restoratives [9].

Like enamel and dentin, bone also contains hydroxyapatite and Type I collagen [6, 11]. Based on the compositions, bone is very similar to dentin [6]. This is the basis for using glass-ionomer cements for bone adhesives and repair applications. Conventional bone cements are acrylate cements that provide fixation of a prosthesis through a so-called “mechanical interlock” between the acrylate resins and porous bone structures [12]. Unlike conventional bone cements, the glass-ionomer cements adhere to bone by means of formation of ionic bonding or salt-bridges. If hybrid systems (containing vinyl and carboxylic acid functionalities) are introduced, in situ polymerization occurs through both groups and dual-curing cements form. As a result, the salt bridges and the mechanical interlocks together play an important role in strengthening the interfacial bonding [6, 11, 13].

Conventional glass-ionomer cements have been used as bone cements [14-16]. Two glass-ionomer-type bone cements are manufactured in Germany, one called IONOS, and the other called Ionocerm. They are two-component systems, in which one component is composed of a copolymer of acrylic and maleic acid in aqueous solution and the second is a calcium-aluminum-fluoro-silicate glass [14-15]. These formulations are similar to the dental glass-ionomer cements manufactured by ESPE Dental Co. (Germany)[17]. One preliminary study on otological surgery showed that these cements were very promising in terms of both adhesion and biocompatibility [14]. Another study showed that they proved valuable in translabyrinthine acoustic neuroma surgery in that that the cements were easy to use, and did not cause observable side effects [15]. Negative results related to lower bonding strengths have been reported, however, [16]. Literature reporting further developments in orthopaedic applications of glass-ionomer cements is sparse, however.

Commercial dental conventional glass-ionomer cement systems, such as poly(acrylic acid) or poly(acrylic acid-co-itaconic acid), have shortcomings. Problems associated with brittleness and low tensile and flexural strengths have limited use of the current conventional glass-ionomer cements to certain low stress-bearing sites such as Class III and Class V cavities. Two major problems regarding the polymer matrix are believed to exist. One problem resides in the direct or very close attachment or proximity of all the carboxylic acid (COOH) groups to the polymer backbone. Not all the carboxyl groups of polyacids are converted to carboxylate groups during the course of the reaction and utilized in salt-bridge formations [18, 19]. Some free COOH groups remain unreacted because they are inaccessible due to steric hindrance. Also, when the polyacrylate chain is largely ionized, the remaining hydrogen becomes firmly bound by electrostatic forces. As a result, the metal ions are increasingly hindered in their movement and capability to react at carboxyl sites. The speculation is that the strength and fracture resistance of the material are weakened due to this steric hindrance, which brings about significantly reduced interactions between aluminum cations (Al++) and carboxylate anions (COO—) (and thus less cluster or salt bridge formation) in the cement.

The second problem deals with molecular weight. It is well-known that mechanical strengths are very much dependent upon molecular weight, except for those primary chemical interactions [20]. Increase in molecular weight enhances the mechanical performance of the materials [21]. The molecular weight of highly ordered poly(acrylic acid) and its copolymers are severely limited by a polyelectrolyte effect. Introduction of monomers with various spacer lengths for the carboxylic acid may serve to increase the molecular weight of these polymers. U.S. Pat. No. 5,369,142 to Culbertson and Kao, and Kao et al., Dent. Mater 12: 44-51 (1996), teach ionomeric glass cement compositions wherein the copolymer is modified to include an amino acid e.g., N-acryloyl substituted amino acid. Kao found increases in diametral tensile, compressive and/or flexural strengths and fracture toughness in cements in which the co-polymer contained an amino acid.

Despite these improvements, however, there remains a need for orthopaedic and dental cements that are stronger and exhibit greater working time in which to allow dental practitioners and orthopaedic surgeons to work with them.

### SUMMARY OF THE INVENTION

One aspect of the present invention is directed to a composition for making an ionomeric cement. The composition contains at least one copolymer containing at least two different carboxylic acid-containing monomers, wherein the copolymer has pendent polymerizable functional groups, and a comonomer containing one or more functional groups reactive with the polymerizable functional groups. The comonomer, at least one of the carboxylic acid containing monomers, or both, contains an amino acid moiety. In preferred embodiments, the copolymer contains three carboxylic acid monomers, two of which are acrylic acid and itaconic acid, and the third monomer is an acryloyl- or methacryloyl derivative of beta-alanine, glycine, aspartic acid, glutamic acid, 6-aminocaproic acid or methionine.

Another aspect of the present invention is directed to an ionomeric cement composition. The cement composition contains, in addition to the copolymer and comonomer, a reactive filler and water.

A further aspect of the present invention is directed to a polymerization system, per se. The system contains at least one copolymer containing at least two different carboxylic acid-containing monomers, wherein the copolymer has pendent polymerizable functional groups, and a comonomer containing one or more groups reactive with the polymerizable functional group. At least one of the monomers, the comonomer or both contains an amino acid moiety.

Yet another aspect of the present invention is directed to a kit that contains at least one package containing various of the ingredients necessary to prepare the ionomeric cement compositions. In preferred embodiments wherein the cement is ultimately prepared using a redox polymerization initiation system, one package contains the reactive filler and the reducing agent (preferably in microencapsulated form), and another package contains the copolymer, comonomer, oxidizing agent and water. In other embodiments a first package contains the reactive filler, copolymer and comonomer, and the second package contains water. If a redox system is used, the first package may also contain the reducing agent and the second package may contain the oxidizing agent. The reducing agent and the oxidizing agent may be in either package. Methods of making and using the cements are also provided.

Ionomeric cement compositions of the present invention are non-biodegradable; they form a rigid hydro-gel that can be loaded with bioactive agents for release over extended periods of time. They exhibit superior biocompatibility, hydrophilicity, reduced cytotoxicity; very low polymerization shrinkage and exotherm; self-healing characteristics in that ionic cross-links that break due to mechanical forces may reform over time; and they exhibit longer working time and stronger and more durable chemical bonding to bone and metal alloys.

### BRIEF DESCRIPTION OF THE DRAWINGS

FIG. 1 is a flow diagram of a “one-pot” synthesis of a terpolymer grafted with isocyanatoethyl methacrylate (IEM), according to the present invention.

FIG. 2 is a bar graph illustrating compressive strengths of ionomeric cements of the present invention having pendent vinyl groups from IEM graft and polymerized via photo-initiation.

FIG. 3 is a bar graph illustrating flexural and diametral tensile strengths of ionomeric cements of the present invention having pendent vinyl groups from IEM graft and polymerized via photo-initiation.

FIG. 4 is a bar graph illustrating compressive and diametral tensile strengths of ionomeric cements of the present invention having pendent vinyl groups from IEM graft and polymerized via redox-initiation.

FIG. 5 is a bar graph illustrating flexural and diametral tensile strengths of ionomeric cements of the present invention having pendent vinyl groups obtained through glycydol methacrylate (GM) grafting and polymerized via redox-initiation.

FIG. 6 is a bar graph illustrating compressive strengths and viscosities of ionomeric cements of the present invention having pendent vinyl groups from IEM grafted and polymerized via photo-initiation, using different vinyl-containing monomers as a comonomer including amino acids, acrylic acid, and HEMA, wherein HEMA=2-hydroxyethyl methacrylate; MASPA=methacryloyl aspartic acid; AGA=acryloyl glutamic acid; ABA=acryloyl beta-alanine; MGA=methacryloyl glutamic acid; MBA=methacryloyl beta-alanine; AASPA=acryloyl aspartic acid; and AA=acrylic acid.

FIG. 7 is a graph illustrating compressive strengths and viscosities of ionomeric cements of the present invention having pendent vinyl groups from IEM grafted and polymerized via photo-initiation, with different formulations of IEM grafted terpolymer/methacryloyl beta-alanine/water.

FIG. 8 is a bar graph illustrating compressive strengths of ionomeric cements of the present invention having pendent vinyl groups from IEM grafted and polymerized via photo-initiation, at different powder/liquid ratios, using methacryloyl beta-alanine as a comonomer.

FIG. 9 is a bar graph illustrating compressive, diametral tensile and flexural strengths of ionomeric cements of the present invention having pendent vinyl groups from IEM grafted and polymerized via photo-initiation, as compared to a commercial GC Fuji II LC glass-ionomer cement.

### DETAILED DESCRIPTION

The term “ionomer” refers to a polymer or copolymer having sufficient pendent ionic groups to undergo a setting reaction or curing reaction in the presence of a reactive filler material and water. Water serves as a reaction medium facilitating the transport of ions between the ionomer and the filler, thereby allowing the acid-base chemical cure setting reaction to occur.

By the term “reactive filler”, it is meant a powdered or otherwise surface-active metal oxide or hydroxide, mineral silicate, or ion leachable glass or ceramic, that is capable of reacting with the ionomer in the presence of water to form a hydrogel. Representative examples of reactive filler materials include calcium-containing and aluminum-containing materials such as calcium alumino silicate glass, calcium alumino fluorosilicate glass, calcium aluminum fluoroborosilicate glass, and like materials known in the art of glass-ionomer cements. In embodiments wherein the cement is used for dental purposes, reactive powders that contain leachable fluorides may be beneficial from the standpoint of cariostatic prevention. Examples of such powders are fluoroaluminosilicate and fluoroaluminoborate ion-leachable glasses.

Polymerizable acids used for preparing ionomers useful for glass-ionomer cement systems include alkenoic acids and unsaturated mono-, di- and tricarboxylic acids. Representative alkenoic acids are described, for example, in U.S. Pat. Nos. 3,655,605; 4,016,124; 4,089,830; 4,143,018; 4,342,677; 4,360,605; 4,376,835 and 5,130,347. Specific examples are acrylic acid, maleic acid, fumaric acid, itaconic acid, crotonic acid, methacrylic acid, the acid chlorides thereof and the acid anhydrides thereof and chloro or bromo derivatives thereof. Particularly preferred monomers are acrylic acid (AA), itaconic acid (IA) and maleic acid (MA), and the chlorides or anhydrides thereof.

The incorporation of naturally occurring amino acids to glass-ionomer bone cements of the present invention promotes biocompatability and enhances mechanical properties. In addition, their incorporation leads to better handling characteristics at higher molecular weight compared to poly (acrylic) acid homopolymers or acrylic acid/itaconic acid copolymers. The amino acid-containing monomer that is used in the present invention may be naturally occurring or synthetic in nature. Examples are glycine, glycylglycine, alanine, valine, leucine, isoleucine, phenylalanine, tyrosine, proline, hydroxyproline, serine, threonine, 3-amino-3-methylbutanoic acid, 6-aminocaproic acid, aminobenzoic acid (meta and para), 4-aminosalicylic acid, iminodiacetic acid, lanthionine, methionine, aspartic acid, glutamic acid, lysine, delta-aminolevulinic acid, beta-alanine, alpha-aminobutyric acid, gamma-aminobutyric acid, gamma, epsilon-diaminopimelic acid, gamma, alpha-diaminobutyric acid, ornithine, omega-aminododecanoic acid, beta-cyanoalanine, epsilon-methylhistidine, canavanine, djenkoic acid, 1-azaserine, gamma-methylene glutamic acid, N-methyl tyrosine, arginine, tryptophan, norvaline, cystine, cysteine, and hydroxylysine.

Preferred amino acids contain acryloyl or methacryoyl groups. Specific examples include acryloyl beta-alanine (ABA), acryloyl glycine (AG), acryloyl aspartic acid (AASPA), acryloyl glutamic acid (AGA), acryloyl 6-aminocaproic acid (AbACA, methacryloyl beta-alanine (MBA), methacryloyl glycine (MG), methacryloyl aspartic acid (MASPA), methacryloyl glutamic acid (MGA) and methacryloyl 6-aminocaproic acid (M6ACA) and methacryloyl methionine (MMET). The many other polypeptide fragments known to those skilled in the art may also be treated according to the present invention with acryloyl or methacryloyl acid chloride or anhydride to produce new monomers suitable for the polymers in the cements of the present invention. For example, the dimer of glutamic acid, glycine-glutamic acid peptide unit, etc., reaction with acryloyl chloride would produce a monomer having high acid and amide group content and thereby be useful herein. The acryloyl or methacryloyl derivatives of amino acids are prepared by known synthetic techniques. See, for example, U.S. Pat. No. 5,369,142 to Culbertson, and Kao et al., Dent. Mater 12: 44-51 (1996).

Preferred copolymers of the present invention are terpolymers having the following formula: Poly(AA-IA-AGA); Poly(AA-IA-MGA); Poly(AA-IA-AG); Poly(AA-IA-MG); Poly(AA-IA-ABA); Poly(AA-IA-MBA); Poly(AA-IA-A6ACA); and Poly(AA-IA-M6ACA). In some embodiments of the present invention, the cement composition contains two or more such copolymers. Preferred combinations include blends of Poly (AA-IA-MGA)/Poly(IA-IA-M6ACA), Poly(AA-IA-MGA)/Poly(AA-IA-MG) and Poly(AA-IA-AASPA)/Poly(AA-IA-MG). The relative amounts of copolymers range from about 10% to about 90% by total weight of copolymers. In preferred embodiments, the copolymers are present in roughly equal amounts, e.g., each about 50% by weight. In other embodiments, the cement contains at least one additional polymer or copolymer known in the art e.g., poly AA, poly IA, copolymers of AA and IA, etc. The addition of these elements may improve toughness and decrease brittleness of the ultimate cement composition.

The pendent carboxylic acid groups on the copolymer must be sufficient in number or percent by weight to bring about the setting or curing reaction in the presence of the reactive powder. To create a source of additional covalent cross-linking, which imparts additional strength to the ultimate ionomeric cement composition, a portion of the carboxylic acid groups is reacted with a bi-functional monomer. Suitable bi-functional monomers are water soluble and undergo a reaction with a carboxylic acid group to form a covalent bond, while maintaining a polymerizable functional group capable of addition polymerization. Thus, one functionality of this monomer facilitates grafting on to the copolymer backbone via the carboxylic acid groups. In preferred embodiments, such functionalities contain nucleophilic groups such as hydroxyl, amine, isocyanato and epoxy. The other functionality is a polymerizable functional group capable of addition polymerization. Preferred polymerizable functional groups include ethylenically unsaturated groups such as vinyl groups, and epoxy groups. In other preferred embodiments, the bi-functional monomer further contains at least one carboxyl or hydroxyl group to enhance water solubility of the copolymer. Examples of suitable bi-functional monomers include acryloyl chloride, methacryloyl chloride, vinyl azalactone, allyl isocyanate, 2-hydroxyethylmethacrylate (HEMA), 2-aminoethylmethacrylate, 2-isocyanatoethyl methacrylate (IEM), acrylic acid, methacrylic acid and N-vinylpyrrolidone. Other examples of suitable bi-functional monomers are described in U.S. Pat. No. 4,035,321 and on columns 5-7 of U.S. Pat. No. 5,130,347 to Mitra. Preferred bi-functional monomers are the amino acid-containing monomers described herein, GM, IEM and HEMA. In general, the bi-functional monomer is present in an amount of from about 5 to about 50%, and preferably from about 10 to about 25%, based upon the mole fractions of the copolymer and the bi-functional monomer.

To effect the additional cross-linking of the cement, one or more comonomers are included in the cement composition. The comonomer contains at least one polymerizable functional group reactive with the polymerizable functional groups on the copolymer backbone (provided by the bifunctional monomer). Suitable polymerizable functional groups in the comonomers include but are not limited to ethylenically unsaturated groups (e.g., alkenyl groups and preferably vinyl groups) and epoxy groups. Ethylenically unsaturated groups, especially those that can be polymerized by means of a free radical mechanism e.g., substituted and unsubstituted acrylates, methacrylates, alkenes and acrylamides, are preferred. In aqueous systems, polymerizable groups that are polymerized by a cationic mechanism e.g., polymerizable ethylenically unsaturated groups such as vinyl ether groups and polymerizable epoxy groups, are less preferred since a free radical mechanism is typically easier to employ in such systems than a cationic mechanism. Preferred comonomers include the amino acid-containing monomers described herein. More preferred comonomers are acryloyl beta-alanine, methacryloyl beta-alanine, acryloyl glutamic acid and methacryloyl glutamic acid. In general, the comonomer is present in the ultimate cement composition in an amount of from about 10% to about 60%, preferably from about 15 to about 50%, and more preferably from about 20 to about 35%, based upon the total weight of the total copolymer/comonomer/water mixture.

Methods for preparing the ionomeric copolymers e.g., via free-radical polymerization, are well known. (See, Crisp et al., “Glass ionomer cement formulations. II. The synthesis of novel polycarboxylic acids,” in J. Dent. Res. 59 (6): 1055-1063 (1980)). In preferred embodiments, the ionomeric copolymer is prepared first and then the polymerizable functional groups are added (e.g., grafted thereon). This sequence substantially eliminates integration of the functional groups into the copolymer backbone. General procedures of grafting pendent polymerizable groups onto the ionomeric copolymers are known in the art e.g., U.S. Pat. No. 5,130,347.

The relative proportions of monomers and comonomer vary depending upon the desired properties of the cement e.g., orthopaedic or dental. In embodiments wherein the amino acid containing monomer is part of the copolymer backbone, the molar ratio of the total amount of other monomer(s) to the amino acid ranges from about 7:1 to about 11:1. In preferred embodiments of the present invention wherein the copolymer contains acrylic acid, itaconic acid and an amino acid, preferably an acryloyl- or methacryloyl amino acid, molar ratios of acrylic acid to itaconic acid to amino acid range from about 10:1:1 to about 5:2:1, and more preferably about 8:2:1 respectively. Likewise, the number average molecular weight (Mn) generally varies from about 3,500 to about 110,000 daltons, and preferably from about 5,500 to about 80,000 daltons.

To prepare the ionomeric cement, the copolymer is mixed with the reactive powder and the comonomer in the presence of water. The components of the ionomeric cement system can be combined (such as by mixing or blending) in a variety of manners and amounts in order to form the ionomeric cements of this invention. Suitable combining techniques include those commonly employed to mix ionomer cement systems. In one technique, a concentrated aqueous solution of the copolymer and comonomer (i.e., ionomer) is mixed with reactive powder at the time of use. The resultant combination of ionomer, reactive powder and water allows the setting reaction to begin. In another technique, the ionomer and powder are provided as a freeze-dried or lyophilized powdered blend under substantially anhydrous conditions i.e., conditions in which there is not sufficient water to allow the setting reaction to proceed. Such systems can then be combined with water at the time of use in order to begin the setting reaction. Once the setting reaction has begun, the resultant mixture may be formed into its desired shape, followed by curing and allowing the mixture to fully harden.

In general, the weight-to-weight ratio of the copolymer(s) to water is from about 1:9 to about 9:1. In general, the concentration of copolymer in water ranges from about 30 to about 70% by weight, and preferably from about 40 to about 65 percent. The resultant aqueous solution has a ratio of polymer to liquid generally ranging from about 1.5 to about 8.

In addition to the particular polymerization initiation system, the reaction mixture may also include a modifying agent such as tartaric acid, thereby providing the ability to achieve a longer working time and a shorter setting time, respectively, when preparing the cement. The term “working time” is generally regarded as referring to the time between the beginning of the setting reaction when the ionomer and reactive powder are combined in the presence of water, and the time the setting reaction proceeds to the point when it is no longer practical to perform further physical work upon the system, e.g. spatulate it or reshape it, for its intended dental or medical application. The term “setting time” refers to the time measured from the beginning of the setting reaction in a restoration to the time sufficient hardening has occurred to allow subsequent clinical or surgical procedures to be performed on the surface of the restoration. In the setting reaction, the reactive filler behaves like a base and reacts with the acidic ionomer to form a metal polysalt which acts as the binding matrix. The setting reaction is therefore characterized as a chemical cure system that proceeds automatically upon mixing the ionomer and reactive filler material in the presence of water. The cement sets to a gel-like state within a few minutes and rapidly hardens to develop strength. See e.g., Prosser et al., J. Chem. Tech. Biotechnol. 29: 69-87 (1979). Tartaric acid and other chelating agents have proven useful in modifying the setting rate such as to provide longer working times for the cements. See e.g., U.S. Pat. Nos. 4,089,830, 4,209,434, 4,317,681 and 4,374,936. In general, an increase in working time results in an increase in setting time as well.

The ratio of powder (i.e., reactive powder or powdered blend of ionomer and reactive powder) to liquid affects the workability of the mixed ionomer cement systems. Ratios higher than about twenty to one (powder to liquid, by weight) tend to exhibit poor workability, while ratios below about one to one tend to exhibit poor mechanical properties, e.g., strength, and hence are not preferred. Preferred ratios are on the order of about 1:3 to about 6:1 and preferably about 1:1 to 4:1 for the reactive powder (i.e., glass plus reducing agent) to liquid system, (copolymer, comonomer and water) and about 1:1 to 16:1 and preferably about 4:1 to 14:1 for the powdered blend system (i.e., glass, reducing agent, copolymer and comonomer). Higher glass (i.e., powder) contents lead to materials with higher compressive strengths, while lower glass contents lead to materials with high flexural strengths and toughness.

Other ingredients, such as polymerization initiators, modifying agents and co-solvents can be added at any time and in any manner that does not prematurely begin the setting reaction or the photo-curing reaction. Modifying agents can be used in the ionomer cement systems of the present invention in order to provide prolonged working times.

The cements are polymerized in accordance with known techniques. At least one initiator is required for most polymerization methods such as those based on oxidation/reduction reactions and ultraviolet and visible light. Photo-initiators promote free radical cross-linking of the ethylenically unsaturated component on exposure to light of a suitable wavelength and intensity. It should also be sufficiently shelf-stable and free of undesirable coloration to permit storage and use under typical medical or dental conditions. The photo-initiator preferably is water-soluble or water-miscible. Photo-initiators bearing polar groups usually possess a sufficient degree of water-solubility or water-miscibility to qualify for this use. The photo-initiator can be used alone but it may be used in combination with a suitable donor compound or accelerator (e.g., amines, peroxides, phosphorus compounds, ketones and alpha-diketone compounds). Preferred visible light-induced initiators include camphoroquinone (which typically is combined with a suitable hydrogen donor such as an amine), diaryliodonium simple or metal complex salts, chromophore-substituted halomethyl-s-triazines and halomethyl oxadiazoles. Particularly preferred visible light-induced photo-initiators include combinations of an alpha-diketone e.g., camphoroquinone, and a diaryliodonium salt, e.g., diphenyliodonium chloride, bromide, iodide or hexafluorophosphate, with or without additional hydrogen donors (such as sodium benzene sulfinate, amines and amine alcohols). Preferred ultraviolet light-induced polymerization initiators include ketones such as benzyl and benzoin, and acyloins and acyloin ethers.

The photo-initiator should be present in an amount sufficient to provide the desired rate of photo-polymerization. The amount depends on factors including the light source, the thickness of the cement layer to be exposed to radiant energy and the extinction coefficient of the photo-initiator. In general, the photo-initiator components are present at a total weight of about 0.01 to about 5%, preferably from about 0.1 to about 5%, based on the total weight (including water) of the unset cement components.

Initiation of polymerization based on oxidation/reduction (“redox”) reactions entails the reaction or cooperation between a reducing agent and an oxidizing agent to produce free radicals that in turn initiate polymerization of the pendant functional groups on the ionomeric copolymer. Like photo-initiators, redox reagents exhibit adequate storage stability and lack of colorization under typical conditions of use. In addition, they should be sufficiently water-soluble to permit ready dissolution in (and discourage separation from) the other components of the cement. They are present in an amount sufficient to permit an adequate free-radical reaction rate. In general, these amounts range from about 0.01 to about 10%, and preferably from about 0.02 to about 5%, based on the total weight (including water) of the unset cement components.

Reducing agents (also termed “activators”) include ascorbic acid, cobalt (II) chloride, ferrous chloride, ferrous sulfate, hydrazine, hydroxylamine (depending upon the choice of oxidizing agent) oxalic acid, thiourea, and salts of a dithionite or sulfite anion. Preferred reducing agents include ascorbic acid and ferrous sulfate. Oxidizing agents (also termed “initiators”) include cobalt (III) chloride, tert-butyl hydroperoxide, ferric chloride, hydroxylamine (depending upon the choice of reducing agent), perboric acid and its salts, and salts of a permanganate or persulfate anion. Preferred oxidizing agents are potassium persulfate, ammonium persulfate and hydrogen peroxide.

Microencapsulation of the reducing agent enhances storage stability and allows the reducing agent and oxidizing agent to be packaged together. Water-soluble and water-insoluble encapsulants can be employed; water-insoluble encapsulants are preferred because they generally provide better long-term storage stability under moist or humid conditions. Suitable encapsulating materials include cellulosic materials as cellulose acetate, cellulose acetate butyrate, ethyl cellulose, hydroxymethyl cellulose and hydroxyethyl cellulose being preferred. Other encapsulants include polystyrene, copolymers of polystyrene with other vinylic monomers and polymethylmethacrylate, copolymers of methylmethacrylate with other ethylenically-unsaturated monomers. Preferred encapsulants are ethylcellulose (EC) and cellulose acetate butyrate (CAB). By varying the choice of encapsulant and the encapsulation conditions, the onset of curing can be tailored to start at times ranging from seconds to minutes. Additional optimization of the encapsulation process allows the mixing and setting times to be customized to a delivery system or to the needs of a specific clinical procedure. The ratio of amount of encapsulant to activator generally ranges from 0.5 to about 10 and preferably from about 2 to about 6.

Typically, the copolymer(s) and comonomer are packaged together. Depending upon the application of the cement and the manner in which polymerization is achieved, various components of the cement compositions may be packaged differently. For example, in the case of a redox-based system, ingredients of the cement composition are divided into two separate packages—the first package containing the copolymer, comonomer, the initiator (i.e., oxidizing agent) and water, and the second package containing the reactive filler and the activator (i.e., the reducing agent). In another embodiment, the first package contains all solid materials (e.g., copolymer, comonomer, reactive filler and if desired, the reducing agent, and the second package contains water and if desired, the initiator. In the case of photo-initiation, the photo-initiator can be included in either the solid (e.g. paste) or liquid parts of the cement.

The cements of the present invention may further contain pigments, nonvitreous fillers, polymerization inhibitors e.g., hydroxytoluene, free radical scavengers e.g., 4-methoxyphenol, butylated hydroxytoluene (BHT), reactive and nonreactive diluents e.g., 2-hydroxyethyl methacrylate, hydroxypropyl methacrylate, surfactants (such as to enhance solubility of an inhibitor e.g., polyoxyethylene) and coupling agents to enhance reactivity of fillers e.g., 3-(trimethoxysilyl)propyl methacrylate. The amount of inhibitor added ranges from about 0.001 to about 2% and preferably from about 0.02 to about 0.5% based on the total weight of the copolymer/comonomer/water mixture. BHT is a preferred inhibitor. It is employed in conjunction with a surfactant (in an amount of about 1%) to enhance solubility.

The cements of the present invention can be used in a variety of applications in the dental and medical fields. Dental applications include restoratives for lining or basing, cementation, sealants and as adhesives and bulk filling. Orthopaedic applications include cements for prosthetic joint (e.g., knee and hip) replacement, bone grafts, and repair of bony defects from disease or trauma.

The invention will now be illustrated by way of the following examples. They are not intended to limit the scope of the presently disclosed invention in any way. Unless indicated otherwise, all parts are by weight.

### EXAMPLE 1

### Synthesis of Methacryloyl L-glutamic Acid (MGA)

NaOH (60 g, 1.5 mol) was dissolved in 250 ml of water and cooled down to around 15° C. L-Glutamic acid (73.6 g, 0.5 mol) was then dissolved in the NaOH aqueous solution. To a three-neck flask, equipped with a thermometer and a mechanical stirrer, containing L-glutamic acid and NaOH aqueous solution, and cooled down to 0 to 5° C., methacryloyl chloride (48.9 ml, 0.5 mol) was added dropwise with vigorous stirring within about one hour while keeping the temperature below 5° C. An additional hour was allowed to complete the reaction after the addition was completed. The solution was acidified to pH=2 with a solution of concentrated HCl (37%) and distilled water (1:1, v/v), oversaturated with NaCl at room temperature, and extracted three to four times with warm ethyl acetate (50-60° C.). The extracted solution was separated using a separation funnel, dried with anhydrous MgSO₄, filtered with a Buchner funnel, and concentrated using a rotary vacuum evaporator to obtain white crystals. The rectangular and transparent crystals were obtained by recrystallization from ethyl acetate.

### EXAMPLE 2

### Synthesis of Methacryloyl Glycine (MG)

The same procedure, as described in synthesis of methacryloyl L-glutamic acid, was utilized with glycine (37.5 g, 0.5 mol), NaOH (40 g, 1.0 mol), water (250 ml), and methacryloyl chloride (48.9 ml, 0.5 mol) to yield a white crystalline material. Needle-like and transparent crystals were obtained after recrystallization from warm ethyl acetate (50-60° C.).

### EXAMPLE 3

### Synthesis of Methacryloyl L-aspartic Acid (MASPA)

A similar procedure, as described in synthesis of methacryloyl L-glutamic acid, was utilized with L-aspartic acid (66.6 g, 0.5 mol), NaOH (60 g, 1.5 mol), water (250 ml), and methacryloyl chloride (48.9 ml, 0.5 mol) to yield a white slurry and viscous material. After being refrigerated overnight, white crystals precipitated out of the slurry material. The white crystals were dried under vacuum at 25° C. after washed using hexane.

### EXAMPLE 4

### Synthesis of Methacryloyl Beta-Alanine (MBA)

A similar procedure, as described in synthesis of methacryloyl L-glutamic acid, was utilized with beta-alanine (44.5 g, 0.5 mol), NaOH (40 g, 1.0 mol), water (250 ml), and methacryloyl chloride (48.9 ml, 0.5 mol) to yield a white crystalline material, which was dried under vacuum at 25° C. after being washed with hexane.

### EXAMPLE 5

### Synthesis of Methacryloyl 6-aminocaproic Acid (M6ACA)

A similar procedure, as described in synthesis of methacryloyl L-glutamic acid, was utilized with 6-aminocaproic acid (65.6 g, 0.5 mol), NaOH (40 g, 1.0 mol), water (250 ml), and methacryloyl chloride (48.9 ml, 0.5 mol) to yield a light yellow oily organic material. After being refrigerated overnight, light yellow crystals precipitated out of the oily material. The yellowish crystals were dried under vacuum at 25° C.

### EXAMPLE 6

### Synthesis of Methacryloyl D,L-methionine (MMET)

A similar procedure, as described in synthesis of methacryloyl L-glutamic acid, was utilized with D,L-methionine (74.6 g, 0.5 mol), NaOH (40 g, 1.0 mol), water (250 ml), and methacryloyl chloride (48.9 ml, 0.5 mol) to yield a light yellow, slightly odiferous crystalline material which was dried under vacuum at 25° C.

### EXAMPLE 7

### Synthesis of Acryloyl L-Glutamic Acid (AGA)

The same procedure, as described in synthesis of methacryloyl L-glutamic acid, was utilized with L-glutamic acid (147.1 g, 1.0 mol), NaOH (120 g, 3.0 mol), water (350 ml), and acryloyl chloride (81.3 ml, 1.0 mol) to yield a white crystalline material. Cubic and transparent crystals were obtained after recrystallization from warm ethyl acetate (50-60° C.) and drying under vacuum at 25° C.

### EXAMPLE 8

### Synthesis of Acryloyl Glycine (AG)

The same procedure, as described in synthesis of methacryloyl L-glutamic acid, was utilized with glycine (75.1 g, 1.0 mol), NaOH (80 g, 2.0 mol), water (350 ml), and acryloyl chloride (81.3 ml, 1.0 mol) to yield a white crystalline material. Cubic and transparent crystals were obtained after recrystallization from warm ethyl acetate (50-60° C.) and drying under vacuum at 25° C.

### EXAMPLE 9

### Synthesis of Acryloyl L-Aspartic Acid (AASPA)

The similar procedure, as described in synthesis of methacryloyl L-glutamic acid, was utilized with L-aspartic acid (133.1 g, 1.0 mol), NaOH (120 g, 3.0 mol), water (350 ml), and acryloyl chloride (81.3 ml, 1.0 mol) to yield a white slurry and viscous material. After being refrigerated overnight, white crystals precipitated out of the slurry material. The white crystals were dried under vacuum at 25° C. after being washed with hexane.

### EXAMPLE 10

### Synthesis of Acryloyl Beta-Alanine (ABA)

The same procedure, as described in synthesis of methacryloyl L-glutamic acid, was utilized with beta-alanine (89.1 g, 1.0 mol), NaOH (80 g, 2.0 mol), water (350 ml), and acryloyl chloride (81.3 ml, 1.0 mol) to yield a white crystalline material, which was dried under vacuum at 25° C. after washing with hexane.

### EXAMPLE 11

### Synthesis of Acryloyl 6-aminocaproic Acid (A6ACA)

The general procedure was similar to that described in synthesis of methacryloyl L-glutamic acid. To an aqueous solution of 6-aminocaproic acid (131.2 g, 1.0 mol), NaOH (80 g, 2.0 mol), and water (350 ml), acryloyl chloride (81.3 ml, 1.0 mol) was added dropwise for about one and one half hours. After reaction was complete, the solution was acidified to pH=2 with a solution of concentrated HCl (37%) and distilled water (1:1, v/v), and oversaturated with NaCl at room temperature. The white slurry and crystalline materials were extracted three to four times with warm ethyl acetate (50-60° C.). The extracted solution was separated using a separation funnel, dried with anhydrous MgSO₄, filtered with a Buchner funnel, and concentrated using a rotary vacuum evaporator to obtain white fine crystals. These fine crystals were dried under vacuum at 25° C.

Yield and melting point of the synthesized monomers in Examples 1-11 are shown in Table 1.

TABLE 1
Yield and Melting Point of the Monomers

| Code | Yield (%) | Melting Point (° C.) |
|---|---|---|
| AGA | 34-38 | 116-118 |
| MGA | 48-55 | 128-130 |
| AG | 33-35 | 128-130 |
| MG | 55-68 | 104-105 |
| ABA | 46 | 84-86 |
| MBA | 62 | 66-69 |
| A6ACA | 92 | 72-76 |
| M6ACA | 76 | 87-90 |
| AASPA | 25 | 135-138 |
| MASPA | 56 | 93-96 |
| MMET | 44 | 71-72 |

### EXAMPLE 12

### One-Pot Synthesis of Poly(Acrylic Acid-co-Itaconic Acid-co-Methacryloyl Glutamic Acid) with Pendent 2-Isocyanatoethyl Methacrylate (IEM)

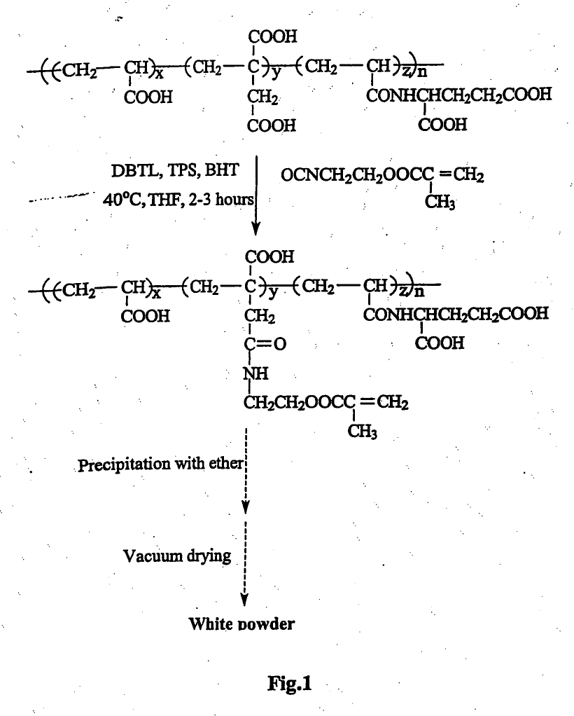

The general reaction scheme is illustrated in FIG. 1. To a three-neck flask, equipped with a thermometer, a nitrogen inlet, a condenser, a drop funnel and a mechanical stirrer, containing 2,2′-azobisisobutyronitrile (AIBN) (0.2645 g) and 125 ml of tetrahydrofuran (THF), a liquid mixture of AIBN (0.2625 g), acrylic acid (AA), (27.38 ml), itaconic acid (IA) (12.99 g) and methacryloyl glutamic acid MGA (10.74 g) and 150 ml of THF were added in about one hour. Before the reaction was initiated, the system was purged with N₂ for 30 min. to displace the dissolved oxygen and then the temperature was raised to around 62-64° C. Nitrogen purging was continued until the reaction was completed. After completion of the additions, the polymerization was run for an additional 10-12 hours at the same temperature. The molar feed ratio for the terpolymer was 8:2:1 (AA:IA:MGA).

The above solution was then cooled down to 35-40° C. and kept at this temperature until the reaction was completed. To the solution, 0.09 g of butylated hydroxy-toluene (BHT), 0.09 g of triphenylstibine (TPS) and 0.6 g of dibutyltin dilaurate (DBTL) were added. After the solution became clear, a mixture of 27.07 g of IEM and 27 ml of THF were added dropwise within 1.5 hours. Another two-hour period was used to complete the reaction. Both FTIR (Fourier transform-infrared spectroscopy) and ¹H-NMR (proton nuclear magnetic resonance spectroscopy) were used to monitor the reaction.

The terpolymer grafted with IEM was recovered by precipitation from diethyl ether, followed by drying in a vacuum oven at room temperature.

The grafted terpolymer was characterized by FT-IR (NMR). The FT-IR spectra were obtained with a FT-IR Spectrometer (Model 1600 FTIR, The Perkin Elmer Co., Norwalk, Conn.), where the sample film was cast on the NaCl crystal. ¹H NMR spectra were obtained on a Bruker AM 400 MHz NMR spectrometer using deuterated dimethylsulfoxide as solvent.

### EXAMPLE 13

### One-Pot Synthesis of Poly(Acrylic Acid-co-Itaconic Acid) with Pendent Glycidyl Methacrylate (GM)

The same procedure, as described in the synthesis of poly(acrylic acid-co-itaconic acid-co-methacryloyl glutamic acid), was used to produce the poly(acrylic acid-co-itaconic acid) copolymer with the molar feed ratio of 7:3.

The formed solution was then cooled down to around 62° C. and kept until reaction was completed. To the solution, 1.05 g of BHT and 3.15 g of N,N-dimethylaniline (DMA) were added. After the solution became clear, a mixture of 30.0 g of GM and 30 ml of THF were added dropwise within about 1.5 hours. Another 30-hour period was used to complete the reaction. Both FTIR and ¹NMR were used to trace the reaction.

The copolymer grafted with GM was recovered by precipitation from diethyl ether, followed by drying in a vacuum oven at room temperature.

The grafted terpolymer was identified by FT-IR and nuclear magnetic resonance (NMR). The FT-IR spectra were obtained with a FT-IR Spectrometer, where the sample film was cast on the NaCl crystal. ¹H NMR spectra were obtained on a Bruker AM 400 MHz NMR spectrometer using deuterated dimethyl-sulfoxide as a solvent.

### EXAMPLE 14

### One-Pot Synthesis of Poly(Acrylic Acid-co-Itaconic Acid-co-Methacryloyl Glutamic Acid) with Pendent Glycidyl Methacrylate (GM)

A similar procedure, as described in Example 12 for synthesis of poly(acrylic acid-co-itaconic acid-co-methacryloyl glutamic acid) with the molar feed ratio of 8:2:1 and in Example 13 for GM grafting, was used to produce the desired terpolymer with pendent vinyl functionality.

### EXAMPLE 15

### Microencapsulation of Ascorbic Acid in Cellulose Acetate Butyrate (CAB)

Into a round bottom flask containing 150 ml of ethyl acetate, 2.0 g of cellulose acetate butyrate (CAB, MW=200,000, butyrate content=17%) was added and dissolved for about 2-3 hours to form a homogenous solution. A water bath was placed under the flask for cooling later. Then 1.0 g of ascorbic acid was added and suspended in the solution for about 15 to 30 minutes, with stirring. 150-200 ml of n-hexane was added dropwise at the rate of 80-100 drops per min. After completion of addition of n-hexane, ice water was added into the bath to harden the formed microcapsules. After 5-10 minutes, cold n-hexane was added to wash the microcapsules.

The microcapsules were recovered by decantation, washed with cold n-hexane, and air-dried or vacuum-dried.

### EXAMPLE 16

### Formulation and Preparation of Vinyl-Containing Hybrid Glass-Ionomer Bone Cements Using Redox Initiators

A two-component system (liquid and solid) was used for formulating redox initiator containing hybrid glass-ionomer cements. The liquid component containing an oxidizer was made by mixing vinyl containing terpolymer (40-60% of total liquid, wt %) with K₂S₂O₆ (0.1-0.5%), butylated hydroxytoluene (BHT, 0.2-0.8%), polyoxyethylene nonylphenol (PEONP, 0.6%), vinyl-containing amino acid (20-30%) and distilled water (15-30%). The solid component containing a reducing agent was prepared by mixing GC Fuji II LC™ glass powder (GC American Dental Co.) with ascorbic acid containing microcapsules (0.2-0.6% of glass powder, wt %), using a vortex with a maximal speed. A powder/liquid ratio (P/L) of 1.0-2.5/1 was used in the formulation. A typical formulation is shown in Table 2.

TABLE 2
Two-Component Redox Glass-Ionomer Bone Cement

| | Powder | Liquid |
|---|---|---|
| Composition | Commercial Fuji II LC | 50 (wt %) Poly(acrylic |
| | glass (GC America) | acid-co-itaconic acid-co- |
| | *ascorbic acid, | glutamic acid) grafted |
| | encapsulated with | with 15% 2- |
| | cellulose acetate | isocyanatoethyl |
| | butyrate, 0.4% of | methacrylate (mol % of |
| | glass (wt %). | polyacid). |
| | *Ratio of ascorbic | 18 (wt %) Acryloyl beta- |
| | acid/cellulose acetate | alanine (comonomer) |
| | butyrate = 1/3 (wt/wt). | 32 (wt %) Distilled water |
| | | 0.1 (wt %) K₂S₂O₈ |
| | | 0.2 (wt %) Butylated |
| | | hydroxytoluene (inhibitor) |
| | | 0.6 (wt %) Polyoxyethylene |
| | | nonylphenol |
| P/L ratio | 2-2.5 | 1 |
| (wt/wt) | | |

### EXAMPLE 17

### Estimates of Curing Time of the Redox System

A metal rod was used to evaluate the working time. The rod was inserted into the center of a mixture of the cement, which was mixed and packed into a small vial with a hole at the bottom. Working time was recorded once the mixing process was initiated. The moment at which the metal rod could not be manually moved in the cement measured from the time of mixing, is defined as the working time. The working times estimated are shown in Table 3.

TABLE 3
Working Time of Self-Cured Hybrid GI Bone Cement*

| | | Ratio | |
|---|---|---|---|
| | | acid | |
| | | encapsulant, | (ascorbic Working Time |
| Code | Encapsulant | wt/wt) | vs. (min, observed) |
| XMG1 | ethyl cellulose | 1:1 | 1 |
| XMG2 | ethyl cellulose | 1:2 | 2 |
| XMG3 | ethyl cellulose | 1:3 | 2-3.5 |
| XMG4 | cellulose acetate | 1:2 | 4-5 |
| | butyrate | | |
| XMG5 | cellulose acetate | 1:3 | 5-6 |
| | butyrate | | |

*Fuji II LC glass was used to make formulations. The polymer liquid was made in formulation of 50/20/30 (grafted terpolymer/ABA/water).

### EXAMPLE 18a

### Specimen Preparation Using Redox Initiators

Polymer solutions were made as described in example 15. GC Fuji II LC™ glass powder was supplied by GC American Dental Co. and used in accordance with manufacturer's instructions. The glass powder versus polymer liquid (P/L) ratio was in the range of 1.5 to 2.5.

Specimens were mixed and fabricated at room temperature, according to manufacturer's instructions. The cylindrical specimens were prepared in molds made of glass tubing, with dimensions of 4 mm diameter by 8 mm length and 4 mm diameter by 2 mm length for compressive (CS) and diametral tensile strength (DTS) tests, respectively. The specimens for the flexural strength (FS) test were prepared using a rectangular Teflon mold with dimensions of 3 mm width by 3 mm depth by 25 mm length. The specimens were removed from molds after 15-20 minutes, and conditioned in distilled water at 37±2° C. for 1 day or 1 week, prior to testing.

### EXAMPLE 18b

### Specimen Preparation Using Visible Light Initiators

The formulations for light-curable materials were made by mixing the vinyl containing terpolymers with 0.5% (wt/wt) of d,l-camphoroquinone (CQ), 1% (wt/wt) of diphenyliodonium chloride (DC), 2-hydroxyethyl methacrylate (HEMA) or vinyl-containing amino acid (i.e., AGA or ABA) and distilled water. Glass powder used in this study was the powder used in the Vitremer tri-cure glass-ionomer system (3M Dental Products), with a powder/liquid ratio (P/L) of 2.5/1 as recommended by 3M Dental Products. Four to five specimens for each formulation were prepared for flexural strength (FS) tests. Specimens were fabricated similar to the procedures as described in Example 17, except that the curing process was completed by using an EXAKT 520 Blue Light Polymerization Unit (9W/71, GmbH, Germany) and a split Teflon mold with a glass window for light exposure was used. The specimens were removed from molds after 15-20 minutes, and conditioned in distilled water at 37±2° C. for 1 day or 1 week, prior to testing.

### EXAMPLE 18c

### Strength Measurements

Testing of specimens was performed on a screw-driven mechanical testing machine (Model Sintech/2G, MTS Systems Corp., Eden Prairie, Minn., USA), with a crosshead speed of 1 mm/min for both diametral tensile strength (DTS) and flexure strength (FS) measurements. The FS test was performed in three-point bending, with a span of 20 mm between supports. The sample sizes were n=5 to 9 for all three tests.

The diametral tensile strength was determined from the relationship DTS=2P/πdt, where P=the load at fracture, d=the diameter of the cylinder and t=the thickness of the cylinder. The flexure strength in three-point bending was obtained using the expression FS=3Pl/2 bd², where P=the load at fracture, l=the distance between the two supports, b=the breadth of the specimen, and d=the depth of the specimen.

To establish controls, the Fuji II glass ionomer (GC America), Vitremer light-cured glass-ionomer (3M Dental product), and Fuji II light-cured control (GC America) (commercially available) were prepared per manufacturing directions for comparison and model systems. Their mechanical strengths are shown in all the related tables and figures.

### EXAMPLE 18d

### Bond Strength Measurement

Freshly extracted human molars were embedded in acrylic resin with the buccal surface facing up. The specimens were ground using a series SiC papers (240, 400, and 600 grit) to expose a superficial dentin surface. A Teflon mold having a cylindrical hole 2 mm in diameter and 5 mm in depth was secured over the dentin surface to establish a bonding area. Two groups of bonded specimens were prepared for each formulation. In the first group, the 600 grit surface was bonded directly. In the second group, the dentin surface was treated with 37% phosphoric acid gel for 15 seconds and then washed and dried of excess water using an air syringe. All surfaces were kept moist until bonded. A thin layer of adhesive liquid with no glass was placed on the dentin surface and cured for 10 seconds. The cement mix was then placed in the cavity to achieve a thickness of 2 mm and photocured for 40 seconds using a Demetron (Demetron Corp.) light-curing unit. The mold was removed and the samples were stored 24 hours at 37° C. before shear testing.

The shear test was conducted by securing the samples in a SynTech tensile tester (MTS Systems, Minneapolis, Minn.) with the bonded specimen perpendicular to the crosshead containing a knife-edge shearing blade. The surface of the tooth was brought flush to the shear blade and secured so that the blade hit at the junction of the bonded specimen and the tooth substrate. The test was run at 0.5 mm/minute. The shear strength was calculated by dividing the maximum breaking force by the area of the bonded specimen.

### EXAMPLE 19

### Inventive Glass-Ionomer Bone Cement Based on Photo Initiation Systems

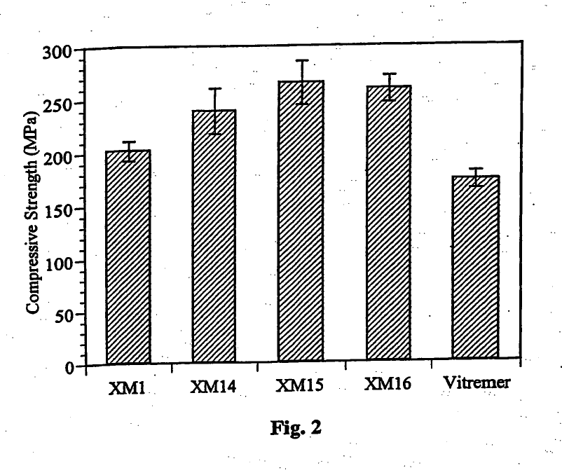

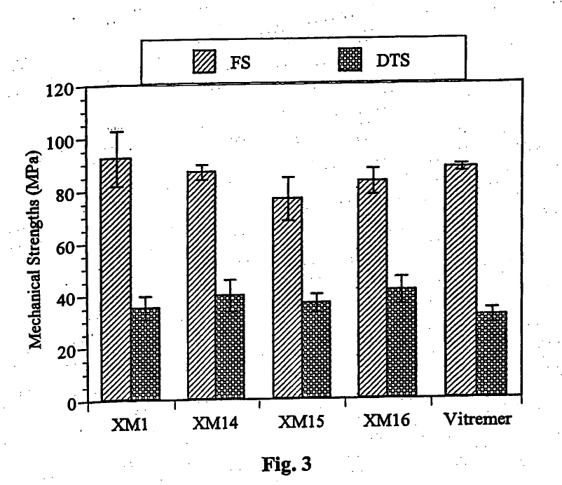

The specimens made in Example 18b were evaluated using the methods described in Example 18c and results are shown in Table 4, and in FIGS. 2 and 3. In Table 4, XM1, XM14, XM15 and XM16 were the cements with the same copolymer (i.e., AA-IA-MGA) but with different liquid formulations and different comonomers, whereas Vitremer was the commercially available light-cured glass-ionomer cement. The Vitremer glass was used to formulate the inventive glass-ionomer cements. The cements were conditioned in distilled water at 37° C. for 1 week.

TABLE 4
Mechanical Strengths of Visible Light Initiated
Hybrid Amino Acid Modified Glass-Ionomer Cements*

| | Liquid | FS | CS | DTS | BM | | |
|---|---|---|---|---|---|---|---|
| | Formulation | [MPa] | [MPa] | [MPa] | [GPa] | Toughness | |
| Material | (wt) | (S.D.) | (S.D.) | (S.D.) | (S.D.) | (N · mm) | Comonomer |
| XM1 | 55:15:30 | 92.1 (10.4) | 201.9 (9.16) | 34.91 (4.48) | 1.19 (0.02) | 15.9 (2.04) | HEMA |
| XM14 | 45:20:35 | 86.6 (2.77) | 238.9 (21.4) | 39.40 (6.01) | 1.45 (0.03) | 13.4 (0.59) | ABA |
| XM15 | 40:30:30 | 76.3 (8.20) | 265.1 (20.5) | 36.38 (3.48) | 1.27 (0.32) | 12.4 (1.23) | AGA |
| XM16 | 55:15:30 | 82.8 (4.86) | 259.0 (12.4) | 41.10 (5.19) | 1.57 (0.06) | 13.1 (0.61) | AGA |
| Vitremer | — | 87.9 (1.35) | 172.7 (8.40) | 31.30 (2.94) | 1.19 (0.04) | 15.0 (0.16) | — |

*Liquid formulation was composed of IEM grafted terpolymer/comonomer/water; Grafting ratio = 25% (mole %); BM = bending modulus; Toughness = area under the load-displacement curve.

Results in Table 4 showed that all the glass-ionomer cements of the present invention were comparable to commercial light-curable product, Vitremer, in most mechanical properties, but significantly higher in CS, DTS, and BM.

### EXAMPLE 20

### Inventive Glass-Ionomer Cement Based on Photo Initiation Systems

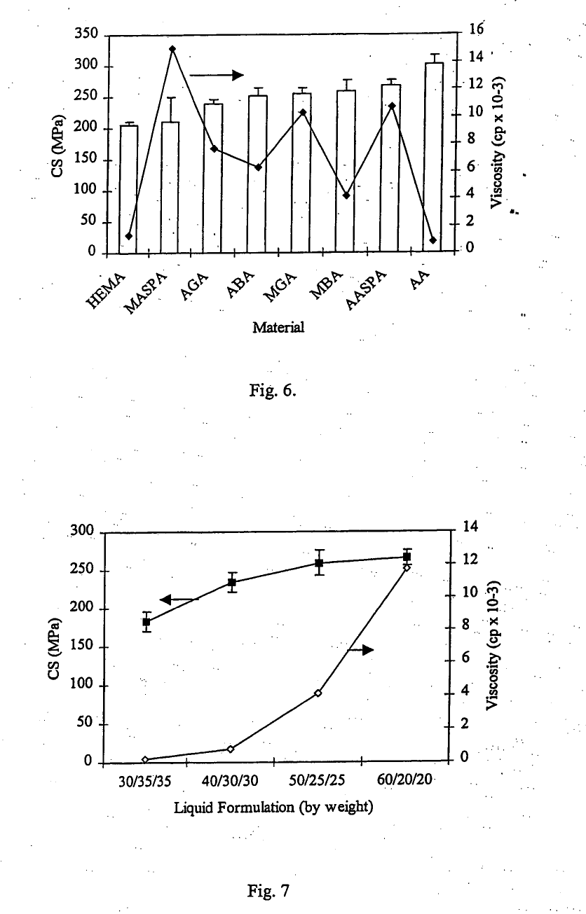

The specimens made in Example 18b were evaluated using the methods described in Example 18c. The results are shown in FIGS. 6, 7, 8 and 9. The copolymer used was the same as in Example 19. The commercially available GC Fuji II LC glass was used to formulate the inventive glass-ionomer cements.

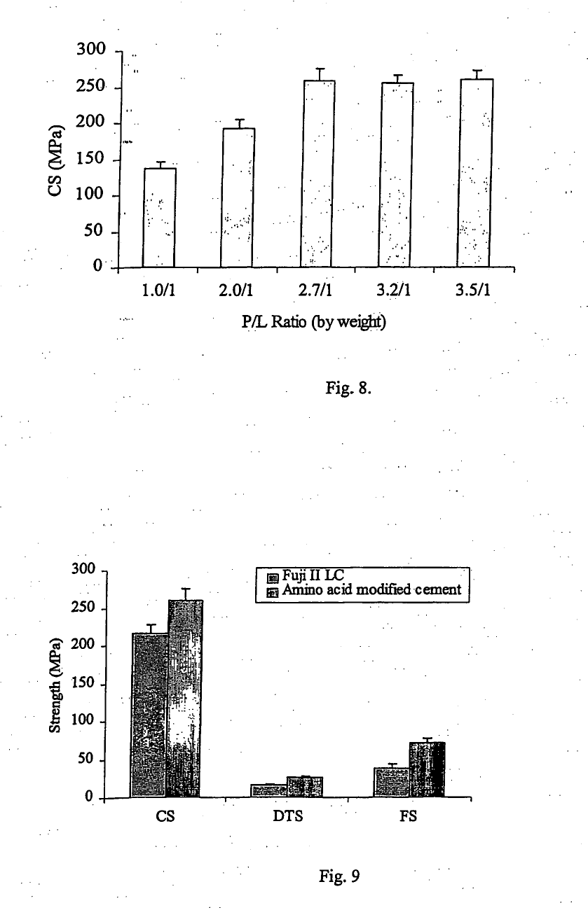

The cements were conditioned in distilled water at 37° C. for 1 week. FIG. 6 shows the compressive strength of the cements and viscosities of the polymer liquids composed of six amino acid derivatives, HEMA and AA. The liquid formulation was 50/25/25 based on polymer/comonomer/water and the P/L ratio was 2.7/1. Among them, AA had the highest compressive strength followed by AASPA, MBA, MGA, ABA, GA, ASPA and HEMA. The viscosity (×10⁻³ cp) of the liquid was in the decreasing order: MASPA>AASPA>MGA>AGA>ABA>MBA>HEMA>AA. Considering strength and working property of the cement, the MBA-containing cement had the lowest viscosity and highest compressive strength. FIG. 7 shows the effect of liquid formulation on CS and viscosity. Both compressive strength and viscosity increased with increasing polymer content. The greater the polymer content in the formulation, the higher were the mechanical strengths. As shown in FIG. 8, the compressive strength of the cement increased with an increase of P/L ratio. However, when the ratio reached 2.7/1, the CS did not increase but instead reached a plateau. FIG. 9 shows the difference between the MBA-modified cement and GC Fuji II LC cement. The MBA modified cement exhibited significantly higher CS (259 MPa), DTS (26.7 MPa) and FS (71.7 MPa), compared to corresponding 216, 16 and 37 MPa for GC Fuji II LC cement.

### EXAMPLE 21

### Shear Bond Strength of Inventive Glass-Ionomer Cement Grafted with Pendent IEM

The specimens made in Example 18b were evaluated using the methods described in Example 18d. The results are shown in Table 5. In Table 5, A2, B2 and C2 were the cements containing the same terpolymers but with different amounts of polyacrylic acid. The copolymer was used as the same as in Example 19. The commercially available GC Fuji II LC glass was used to formulate the inventive glass-ionomer cements. Polyacrylic acid was also used in some of the formulations. Surface treatment of the dentin was divided into etching and non-etching as described in Example 18d. The cements were conditioned in distilled water at 37° C. for 1 week.

TABLE 5
Shear Bond Strength (SBS) of Hybrid Amino Acid Modified
Glass-Ionomer Cements Grafted with IEM, formulating
with an Amino Acid Comonomer and polyacrylic acid

| | SBS [MPa] | SBS [MPa] Non- | Polyacrylic acid |
|---|---|---|---|
| Material | Ethed(S.D.) | etched(S.D.) | added (wt %) |
| A2 | 11.4(0.41) | 19.5(4.8) | 0 |
| B2 | 11.1(5.42) | 15.1(4.1) | 6 |
| C2 | 7.41(2.68) | 19.9(4.2) | 13 |
| Fuji II LC | 12.0(4.07) | N/A | N/A |

*Grafting ratio = 25%; P/L ratio = 2/1; Liquid formulation = 50:20:30; ABA was used as comonomer; Cements were light-cured and were conditioned in distilled for 7 days before testing.

### EXAMPLE 22

### Inventive Glass-Ionomer Bone Cement Based on Redox Initiation Systems

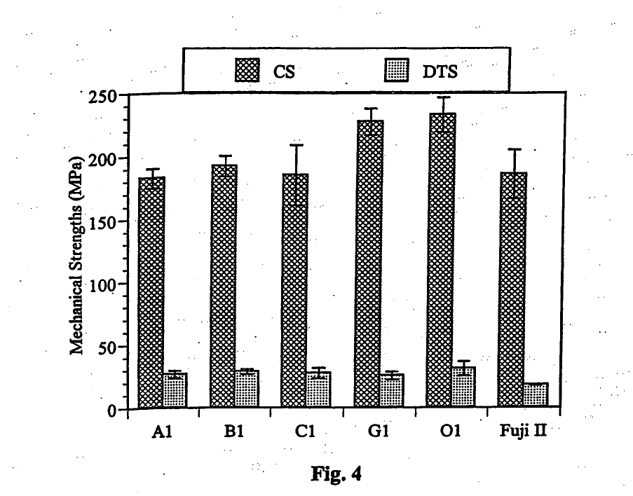

The polymers synthesized in Example 12 and specimens made in Examples 18a and b were evaluated using the methods described in Example 18c and results are shown in Tables 6, 7 and 8, and FIG. 4. In Table 6, A1, B1 and C1 were the cements with different liquid formulations; In Table 7, D1 to G1 were the cements with different grafting ratios. In Table 8, L1 to O1 were the cements with different P/L ratios. Fuji II was the commercially available glass-ionomer cement. The Fuji II LC glass was used to formulate the inventive glass-ionomer cements. The cements were conditioned in distilled water at 37° C. for 1 week.

TABLE 6
Mechanical Strengths of Redox Initiated Hybrid Amino
Acid Modified Glass-Ionomer Cements - Effect of
Components in Liquid Formulation on Properties*

| | Liquid | CS [Mpa] | | |
|---|---|---|---|---|
| Material | Formulation (wt) | (S.D) | DTS [Mpa] (S.D) | CT (min) |
| A1 | 40/30/30 | 182.7 (7.72) | 26.5 (2.98) | 1.92 |
| B1 | 50/18/32 | 192.2 (8.07) | 28.6 (3.11) | 2.08 |
| C1 | 60/15/25 | 185.0 (23.8) | 27.5 (4.18) | 3.22 |
| Fuji II | — | 185.8 (47.9) | 18.0 (0.30) | — |

*Grafting ratio = 15%; P/L ratio = 2/1; Amount of activator (ascorbic acid) = 0.3%; ABA was used as comonomer; CT = curing time.

TABLE 7
Effect of IEM Grafting Ratio on Polymer on Properties*

| | Grafting | | | | |
|---|---|---|---|---|---|
| | Ratio | Liquid | | DTS | |
| | (molar | Formulation | CS [Mpa] | [Mpa] | CT |
| Material | ratio) | (wt) | (S.D) | (S.D) | (min) |
| D1 | 15% | 40/30/30 | 182.7 (7.72) | 26.5 (2.98) | 1.92 |
| E1 | 30% | 40/30/30 | 173.8 (3.24) | 29.6 (4.46) | 2.13 |
| F1 | 15% | 60/15/25 | 185.0 (23.8) | 27.5 (4.18) | 3.22 |
| G1 | 30% | 60/15/25 | 227.1 (10.4) | 25.4 (4.98) | 3.42 |

*P/L ratio = 2/1; Amount of activator = 0.3%.

| | P/L Ratio | | | |
|---|---|---|---|---|
| Material | (wt) | CS (MPa) (S.D) | DTS (MPa) (S.D) | CT (min) |
| L1 | 1.5/1 | 162.9 (10.3) | 26.9 (2.77) | 2.32 |
| M1 | 2.0/1 | 192.2 (8.07) | 28.6 (3.11) | 2.70 |
| N1 | 2.5/1 | 212.5 (8.41) | 30.5 (5.25) | 2.05 |
| O1 | 3.0/1 | 232.7 (13.7) | 31.0 (5.67) | 1.75 |

*Grafting ratio = 15%; Amount of activator = 0.3%;
Ratio for liquid formulation = 50/18/32.

Mechanical strengths of redox-initiated glass-ionomer cements of the present invention and the effects of grafting ratios and P/L ratios are described in Tables 6, 7 and 8. The redox system exhibited improved DTS and comparable CS, compared to the Fuji II control, as shown in Table 6. Different grafting seems not to have much effect on mechanical strengths of the cements. The higher the P/L ration, the higher the CS and DTS, as shown in Table 8.

### EXAMPLE 23

### Inventive Glass-Ionomer Bone Cement Grafted with Pendent GM

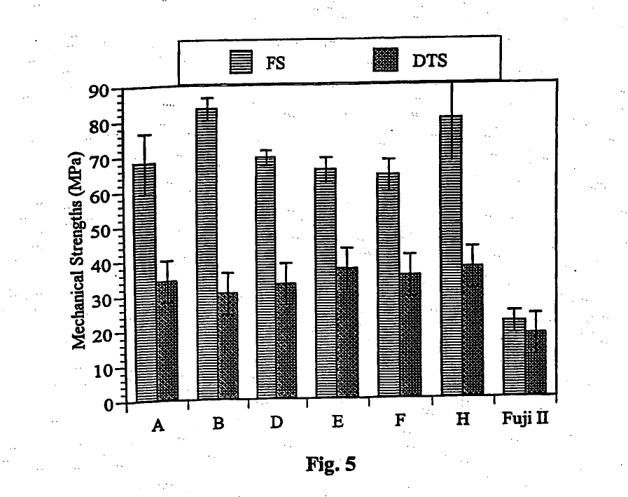

The polymers synthesized in Example 13 and specimens made following Example 18 were evaluated using the methods described in Example 18c and results are shown in Table 9 and FIG. 5. In Table 9, A, B, D, E and H were the cements with different liquid formulations initiated with visible light, whereas F was the cement initiated using redox system. The Fuji II LC glass was used to formulate the inventive glass-ionomer cements. The cements were conditioned in distilled water at 37° C. for 1 week.

TABLE 9
Mechanical Strengths of Hybrid Amino Acid Modified
Glass-Ionomer Cements Grafted with Glycidyl Methacrylate*
and containing an Amino Acid Comonomer

| | Liquid | | | FS | | DTS | |
|---|---|---|---|---|---|---|---|
| | Formulation | P/L | Grafting | [MPa] | CS [MPa] | [MPa] | |
| Material | (wt) | Ratio | Ratio | (S.D.) | (S.D.) | (S.D.) | Initiation |
| A | 50:20:30 | 2.7 | 15% | 68.1 (8.5) | 199.3 (7.9) | 34.1 (1.8) | LC |
| B | 60:15:25 | 2.7 | 15% | 83.2 (3.8) | 199.6 (3.7) | 30.4 (1.8) | LC |
| D | 50:20:30 | 2.0 | 15% | 69.2 (2.4) | 174.8 (12.6) | 32.9 (2.3) | LC |
| E | 50:20:30 | 3.5 | 15% | 65.7 (3.5) | 208.5 (6.3) | 37.1 (2.2) | LC |
| F | 50:20:30 | 2.7 | 15% | 64.0 (4.5) | 221.3 (12.5) | 35.1 (4.3) | Redox |
| H | 50:20:30 | 2.7 | 30% | 80.0 (11.9) | 207.8 (10.3) | 37.3 (2.2) | LC |
| Fuji II | — | | — | 18.0 (0.3) | 189.5 (19.4) | 21.6 (3.2) | — |

*In liquid formulation, poly(acrylic acid-co-itaconic acid) copolymer was used instead of poly(acrylic acid-co-itaconic acid-co-methacryloyl glutamic acid) terpolymer; Glycidyl methacrylate was used as a grafting agent; The specimens were conditioned for 1 week prior to testing; LC stands for photo-initiation, whereas redox represents redox initiation.

As shown in Table 9, all glycidyl methacrylate grafted polycarboxylic acid-containing glass ionomers exhibited much higher values in FS (64.0 to 83.2 Mpa), CS (174.8 to 221.3 Mpa) and DTS (30.4 to 37.3 Mpa) compared to Fuji II control (18.0 in FS, 189.5 in CS and 21.6 in DTS), even though there was no amino acid incorporated into the polymer backbone.

### CITATIONS OF PUBLICATIONS REFERENCED IN THE BACKGROUND SECTION

1. A. D. Wilson et al., J. Appl. Chem. Biotechnol. 21: 313 (1971).
2. P. Hotz et al., Br. Dent. J. 142: 41-47 (1977).
3. W. R. Lacefield et al., J. Prosthet. Dent. 53: 194-198 (1985).
4. L. Forsten, Scand. J. Dent. Res. 85: 503-504 (1977).
5. J. W. McLean et al., Quintessence Int. 16: 333-343 (1985).
6. R. G. Craig, Restorative Dental Materials. 10th ed., St. Louis: Mosby-Year Book, Inc., (1997).
7. J. W. Nicholson et al., J. Biomater. Sci., Polym. Edn. 2 (4): 277-285 (1991).
8. W. R. Hume et al., J. Dent. Res. 67 (6): 915-918 (1988).
9. A. D. Wilson et al., Glass-Ionomer Cement. Chicago, Quintessence Publ Co. (1988).
10. A. D. Wilson, Int. J. Prosthodont. 2: 438-446 (1989).
11. K. J. Anusavice, Phillips' Science of Dental Materials. 10th ed., Philadelphia, Pa.: W. B. Saunders Company, (1996).
12. G. Lewis, J. Biomed Mater. Res. 38: 155-182 (1977).
13. A. D. Wilson, Int. J. Prosthodont. 3: 25-429 (1990).
14. G. Babighian, J. Laryngology & Otology 106: 954-959 (1992).
15. R. T. Ramsden et al., J. Laryngology & Otology 106: 949-953 (1992).
16. S. Firedman et al., Endodontics & Dental traumatology 9 (3): 101-5 (1993).
17. Y. Momoi et al., Dent. Mater. J. 14 (2): 109-119 (1995).
18. S. Crisp et al., J. Dent. Res. 53 (6): 1414-1419 (1974).
19. S. Matsuya et al., Dent. Mater. J. 3: 210-219 (1984).
20. L. H. Sperling, Introduction to Physical Polymer Science. 2nd ed., New York: John Wiley & Sons, Inc. (1992).
21. A. D. Wilson et al., J. Dent. Res. 68 (2): 89-94 (1989).

All patent and non-patent publications cited in this specification are indicative of the level of skill of those skilled in the art to which this invention pertains. All these publications and patent applications are herein incorporated by reference to the same extent as if each individual publication or patent application was specifically and individually indicated as being incorporated by reference herein.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A composition for making an ionomeric cement, comprising at least one copolymer comprising at least two different carboxylic acid-containing monomers, wherein said copolymer has added thereon a bifunctional monomer having pendent polymerizable functional groups, and a comonomer containing one or more polymerizable functional groups reactive with said polymerizable functional groups on said bifunctional monomer, wherein said comonomer, at least one of said carboxylic acid containing monomers, or both, comprises an amino acid.

2. The composition of claim 1 wherein one of said carboxylic acid-containing monomers comprises acrylic acid (AA).

3. The composition of claim 1 wherein one of said carboxylic acid-containing monomers comprises itaconic acid (IA).

4. The composition of claim 1 wherein said two monomers comprise acrylic acid and itaconic acid.

5. The composition of claim 1 wherein said copolymer comprises three different carboxylic acid-containing monomers, one of which comprises an amino acid.

6. The composition of claim 5 wherein said amino acid is an acryloyl amino acid or a methacryloyl amino acid.

7. The composition of claim 6 wherein said amino acid is acryloyl amino acid selected from the group consisting of acryloyl beta-alanine (ABA), acryloyl aspartic acid (AASPS), acryloyl glycine (AG), acryloyl glutamic acid (AGA), and acryloyl 6-aminocaproic acid (A6ACA).

8. The composition of claim 6 wherein said amino acid is a methacryloyl amino acid selected from the group consisting of methacryloyl beta-alanine (MBA), methacryloyl glycine (MG), methacryloyl aspartic acid (MASPA), methacryloyl 6-aminocaproic acid (M6ACA) and methacryloyl methionine (MMET).

9. The composition of claim 1 wherein said copolymer comprises Poly(AA-IA-AGA) or Poly(AA-IA-MGA).

10. The composition of claim 1 wherein said copolymer comprises Poly(AA-IA-AG) or Poly(AA-IA-MG).

11. The composition of claim 1 wherein said copolymer comprises Poly(AA-IA-ABA) or Poly(AA-IA-MBA).

12. The composition of claim 1 said copolymer comprises Poly(AA-IA-A6ACA) or Poly(AA-IA-M6ACA).

13. The composition of claim 1 wherein said pendent polymerizable functional groups on said bifunctional monomer comprise ethylenically unsaturated groups.

14. The composition of claim 13 wherein said bifunctional monomer is glycidyl methacrylate (GM) which is grafted onto said copolymer.

15. The composition of claims 13 wherein said bifunctional monomer is 2-isocyanatoethylmethacrylate (IEM) which is grafted onto said copolymer.

16. The composition of claim 1 wherein said pendent polymerizable functional groups on said bifunctional monomer comprise epoxy groups.

17. The composition of claim 1 wherein said comonomer comprises an acryloyl amino acid or a methacryloyl amino acid.

18. The composition of claim 1 wherein said comonomer comprises acryloyl beta-alanine.

19. The composition of claim 1 wherein said comonomer comprises 2-hydroxyethyl methacrylate (HEMA).

20. The composition of claim 1 wherein both one of said carboxylic-acid containing monomers and said co-monomer comprise an amino acid.

21. The composition of claim 1 comprising first and second copolymers, each of which contains an amino acid-containing monomer, wherein the amino acid in each of said copolymers is different.

22. The composition of claim 21 wherein combinations of said first and second copolymers are Poly(AA-IA-MGA)/Poly(AA-IA-M6ACA), Poly(AA-IA-MGA)/Poly(AA-IA-MG) or Poly(AA-IA-AASPA)/Poly(AA-IA-MG).

23. The composition of claim 1 further comprising polyacrylic acid.

24. An ionomeric cement comprising the composition of claim 1, a reactive filler and water.

25. The cement of claim 24 further comprising a polymerization initiator.

26. The cement of claim 25 wherein said initiator comprises a photo-initiator.

27. The cement of claim 25 wherein said initiator comprises a reducing agent and an oxidizing agent.

28. The cement of claim 27 wherein said reducing agent comprises ascorbic acid.

29. The cement of claim 27 wherein said reducing agent is in encapsulated form.

30. The cement of claim 24 further comprising a polymerization inhibitor.

31. The cement of claim 30 wherein said inhibitor is butylated hydroxytoluene.

32. The cement of claim 24 further comprising a modifying agent.

33. The cement of claim 32 wherein said modifying agent comprises tartaric acid.

34. The cement of claim 24 further comprising polyacrylic acid.

35. A kit for preparing an ionomeric cement composition, comprising: a first package containing at least one copolymer comprising at least two different carboxylic acid-containing monomers, wherein said copolymer has added thereon a bifunctional monomer having pendent polymerizable functional groups, and a comonomer containing one or more polymerizable functional groups and that is reactive with said polymerizable functional group on said bifunctional monomer, wherein said comonomer, at least one of said carboxylic acid-containing monomers, or both, comprises an amino acid.

36. The kit of claim 35 wherein said first package further comprises water, and wherein said kit further comprises a second package comprising a reactive filler.

37. The kit of claim 36 wherein said second package further comprises a reducing agent.

38. The kit of claim 35 wherein said first package further comprises a reactive filler and wherein said kit further comprises a second package comprising water.

39. The kit of claim 35 wherein said copolymer and said comonomer are present in lyophilized form.

40. The kit of claim 35 further comprising a second package and wherein one of said packages further comprises a reducing agent and the other of said packages further comprises an oxidizing agent.

41. A polymerization system comprising at least one copolymer comprising at least two different carboxylic acid-containing monomers, one of said monomers being an amino acid, wherein said copolymer has added thereon a bifunctional monomer having pendent polymerizable functional groups, and a comonomer containing one or more functional groups reactive with said polymerizable functional groups on said bifunctional monomer.

42. A polymerization system comprising at least one copolymer comprising at least two different carboxylic acid-containing monomers, wherein said copolymer has added thereon a bifunctional monomer having pendent polymerizable functional groups, and an amino acid comonomer having polymerizable functional groups reactive with said polymerizable functional groups on said bifunctional monomer.

43. The composition of claim 1, wherein said copolymer comprises said comonomer.
